(19) United States
(12) Patent Application Publication
(10) Pub. No.: US 2026/0295946 A1
(43) Pub. Date: Oct. 1, 2026

(54) JOINING SYSTEM

(71) Applicant: Nippon Avionics Co., Ltd., Yokohma-shi (JP)

(72) Inventor: Shungo NISHIHARA, Yokohama-shi (JP)

(21) Appl. No.: 19/632,057

(22) Filed: Mar. 27, 2026

(30) Foreign Application Priority Data
Mar. 28, 2025 (JP) 2025-055582

(51) Int. Cl. B29C 65/08; B29C 65/00

(52) U.S. Cl. CPC B29C 65/08; B29C 66/0014

(57) ABSTRACT

A joining system (10) includes a heater (21) that supports, from below, a workpiece (W) including a first component (W1), a second component (W2) disposed above the first component (W1), and a joining material (M) disposed between the first component (W1) and the second component (W2), and heats at least the joining material (M) to effect joining of the first component (W1) and the second component (W2) with the joining material (M); a cup-shaped cover (30) that covers, from above, at least the joining material (M) and the second component (W2) of the workpiece (W) in a non-contact manner during the joining; and an ultrasonic vibration applying device (80) that applies ultrasonic vibration to the cover (30) during the joining, thereby applying ultrasonic vibration to the workpiece (W) via the cover (30).

### TECHNICAL FIELD

The present disclosure relates to a joining system.

### BACKGROUND

As disclosed in Patent Literature 1 (JP 2010-56188 A), a joining apparatus for joining a first component and a second component disposed above the first component with a joining material (solder in Patent Literature 1) is known.

In joining using a joining material, good joining quality may not be obtained because problems such as voids in the joining material, oxidation of the joining material, deformation of a workpiece, cracks, or misalignment of the second component may occur.

### SUMMARY

It is an object of the present disclosure, in joining using a joining material, to make at least one of the above-described problems less likely to occur and to obtain good joining quality.

To solve the above-described problems, according to the present disclosure, there is provided a joining system comprising: a heater configured to support, from below, a workpiece including a first component, a second component disposed above the first component, and a joining material disposed between the first component and the second component, and to heat at least the joining material to effect joining of the first component and the second component with the joining material; a cup-shaped cover configured to cover, from above, at least the joining material and the second component of the workpiece in a non-contact manner during the joining; and an ultrasonic vibration applying device configured to apply ultrasonic vibration to the cover during the joining, thereby applying ultrasonic vibration to the workpiece via the cover.

According to the present disclosure, there is provided a joining system comprising: a heater configured to support, from below, a workpiece including a first component, a second component disposed above the first component, and a joining material disposed between the first component and the second component, and to heat at least the joining material to effect joining of the first component and the second component with the joining material; a cup-shaped cover configured to cover, from above, at least the joining material and the second component of the workpiece in a non-contact manner during the joining; a gas supply device configured to supply gas during the joining to an internal space of the cover that accommodates at least the joining material and the second component; and a controller configured to control the gas supply device such that the gas in the internal space is at a pressure greater than atmospheric pressure.

According to the present disclosure, in joining using a joining material, at least one of the above-described problems is less likely to occur, and good joining quality can be obtained.

### BRIEF DESCRIPTION OF THE DRAWINGS

FIG. 1 is a diagram showing the configuration of a joining system according to an embodiment.

FIG. 2 is a plan view of a lower portion of the cover when the cover is cut along a plane orthogonal to the up-down direction and passing through the central axis of the through-hole.

FIG. 3 is a flowchart of a joining process.

FIG. 4 is a diagram showing the configuration of a relevant portion of a joining system according to a modification.

FIG. 5 is a diagram showing the configuration of a relevant portion of a joining system according to a modification.

FIG. 6 is a plan view of a lower portion of the cover according to a modification when the cover is cut along a plane orthogonal to the up-down direction and passing through the central axis of the through-hole.

FIG. 7 is a diagram showing the configuration of a relevant portion of a joining system according to a modification.

### EMBODIMENTS

Hereinafter, an embodiment of the present disclosure will be described with reference to the drawings. In the following description, directional terms, such as "above," "below," "up," "down," "upper," and "lower," are defined for convenience to specify relative positional relationships and are not intended to limit an actual orientation of the joining system 10. For example, the up-down direction in the following description may or may not coincide with the direction of gravity. "Plan view" refers to a view seen from above.

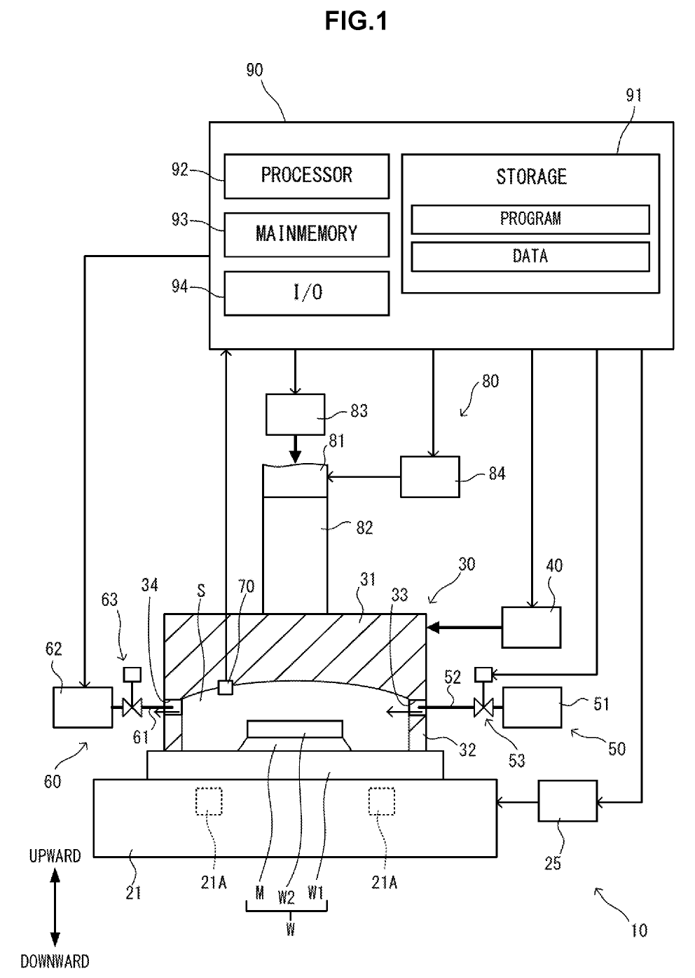

A joining system 10 according to this embodiment shown in FIG. 1 joins a component W1 and a component W2 of a workpiece W with a joining material M, particularly by heating the joining material M. The workpiece W includes the component W1, the component W2 disposed above the component W1, and the joining material M interposed therebetween. The joining material M is made of one of a brazing material, a solder, a sintering material, a thermoplastic resin, and a thermosetting resin. Each of the thermoplastic resin and the thermosetting resin may include a resin to which a specific function such as conductivity is imparted by mixing another material such as metal particles. The joining material M made of the brazing material, the solder, or the thermoplastic resin melts or softens once when heated and, after heating ends, hardens into a solid, thereby joining the components W1 and W2. The joining material M made of the sintering material joins the components W1 and W2 by being sintered through heating. The thermosetting resin joins the components W1 and W2 by being cured through heating. The component W1 is, for example, a lead frame made of copper. The component W2 is, for example, a power semiconductor device. The joining material M may be configured as a plurality of bumps that respectively connect a plurality of terminals of the power semiconductor device to a plurality of terminals of the lead frame.

The joining system 10 includes a heater 21, a power supply circuit 25, a cover 30, a drive device 40, a gas supply device 50, a gas exhaust device 60, a pressure sensor 70, an ultrasonic vibration applying device 80 (hereinafter also simply referred to as a device 80), and a controller 90. In FIG. 1, only the cover 30 is shown in section.

The heater 21 includes a heat source 21A that generates heat by Joule heating based on a heating current supplied from the power supply circuit 25, which includes, for example, an inverter circuit, and heats the workpiece W with heat generated by the heat source 21A. The heater 21 also functions as a stage that supports the workpiece W from below. The heater 21 heats, for example, a lower surface of the component W1 of the workpiece W. This allows the workpiece W to be heated from a surface having a large heat capacity, thereby improving joining quality. The heat source 21A of the heater 21 may be arranged at a position that does not overlap the joining material M. This allows the workpiece W to be heated from a position away from a surface from which voids in the joining material M are likely to escape (here, a side surface of the joining material M), thereby obtaining good joining quality. In plan view, the heat source 21A may be formed in a ring shape surrounding the joining material M. This reduces heating nonuniformity. The power supply circuit 25 controls an amount of heating current supplied to the heater 21 under control of the controller 90. The central axes of the heat source 21A, the workpiece W, and a horn 82 to be described later preferably coincide with each other in the up-down direction.

The cover 30 is formed in a cup shape with an open lower end. The cover 30 is shaped to cover the component W2 and the joining material M in a non-contact manner while the lower end of the cover 30 is in contact with an upper surface of the component W1. An inner surface of the cover 30 is spaced apart from the component W2 and the joining material M. As will be described later, ultrasonic vibration from the device 80 is applied to the cover 30. The cover 30 transmits the ultrasonic vibration from the device 80 to the component W1 with which the lower end of the cover 30 is in contact. The cover 30 may be formed of a material having ultrasonic transmissivity and low thermal conductivity so that heat transmitted from the heater 21 through the component W1 of the workpiece W is not transmitted to the device 80, particularly to a horn 82 to be described later. Examples of such a material include LCP (liquid crystal polymer) and glass. The cover 30 may be formed of another material, such as metal. In this case, heat-dissipation fins may be formed on an outer surface of the cover 30 so as to improve heat dissipation. Alternatively, only a portion of the cover 30 that contacts the component W1 and/or a portion of the cover 30 that contacts the horn 82 to be described later may be formed of the above-described material, and the other portion may be formed of metal or the like.

The cover 30 includes a top portion 31 facing the component W2, and a cylindrical portion 32 that extends downward from the top portion 31, reaches the component W1, and surrounds the component W2 and the joining material M in plan view. The top portion 31 and the cylindrical portion 32 together define the cup shape of the cover 30. The top portion 31 and the cylindrical portion 32 define an internal space S of the cover 30 in which the component W2 and the joining material M are accommodated. The cover 30 may be formed into a hemispherical shell shape.

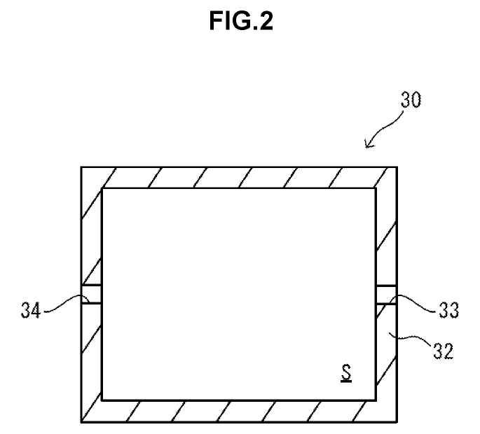

The cylindrical portion 32 is provided with two through holes 33 and 34 that communicate the internal space S of the cover 30 with a space outside the cover 30. The gas supply device 50 is connected to the through hole 33, and the gas exhaust device 60 is connected to the through hole 34. As shown in FIG. 2, the through holes 33 and 34 are arranged at positions opposite to each other across a center of the cover 30 as viewed from above.

The drive device 40 in FIG. 1 is formed from, for example, a robot including a linear motor, a ball screw mechanism, or the like, and moves the cover 30 at least in the up-down direction under the control of the controller 90.

The gas supply device 50 includes a gas cylinder 51, a gas pipe 52, and a flow control valve 53. The gas cylinder 51 stores an inert gas such as nitrogen gas, argon gas, or neon gas. One end of the gas pipe 52 is connected to the gas cylinder 51. The other end of the gas pipe 52 is connected to the through hole 33 of the cover 30. With this configuration, the inert gas from the gas cylinder 51 is supplied to the internal space S of the cover 30 via the gas pipe 52 and the through hole 33. The flow control valve 53 is arranged in the middle of the gas pipe 52, and controls the flow rate of inert gas flowing through the gas pipe 52. The controller 90 controls the supply amount of inert gas to the internal space S of the cover 30 by controlling the opening degree of the flow control valve 53.

The gas exhaust device 60 includes an exhaust pipe 61, a fan 62, and a flow control valve 63. One end of the exhaust pipe 61 is connected to the through hole 34 of the cover 30. The other end of the exhaust pipe 61 is connected to the fan 62. When the fan 62 operates, gas in the internal space S of the cover 30 is exhausted via the exhaust pipe 61. The flow control valve 63 is arranged in the middle of the exhaust pipe 61, and controls the flow rate of gas flowing through the exhaust pipe 61. The controller 90 controls the exhaust amount of gas (air and/or inert gas) from the internal space S of the cover 30 by controlling the rotation speed of the fan 62 and/or the opening degree of the flow control valve 63.

The pressure sensor 70 detects a gas pressure in the internal space S of the cover 30, and supplies the detected gas pressure to the controller 90.

The device 80 applies ultrasonic vibration to the workpiece W during joining. The device 80 includes an ultrasonic transducer (also simply referred to as a transducer) 81, an ultrasonic horn (also simply referred to as a horn) 82, a drive device 83, and a power supply circuit 84. The transducer 81 is formed from, for example, a Langevin transducer, and vibrates by high-frequency power from the power supply circuit 84 to generate ultrasonic vibration. The horn 82 is fixed to the transducer 81. The drive device 83 is formed from a linear motor, a ball screw mechanism, or the like. The drive device 83 moves the transducer 81 and the horn 82 downward, and presses the distal end (lower end) of the horn 82 against the cover 30. During pressing, the transducer 81 generates ultrasonic vibration. The generated ultrasonic vibration is amplified by the horn 82 and applied to the cover 30. The device 80 is controlled by the controller 90. Specifically, the controller 90 controls operation of the drive device 83 and vibration of the transducer 81 (more specifically, operation of the power supply circuit 84).

The controller 90 may be constituted by any of various computers, and includes a nonvolatile storage 91 that stores programs and the like, and a processor 92 that executes the programs stored in the storage 91. The storage 91 also stores data used in the processing described below. The processor 92 includes one or more CPUs (central processing units) or the like. The controller 90 further includes a main memory 93 that provides a work area for the processor 92, and an I/O (input/output) 94 that relays electrical signals transmitted and received between the processor 92 and components outside the controller 90. The I/O 94 may include a circuit that converts a control signal from the processor 92 from digital to analog and supplies the converted signal to a controlled device.

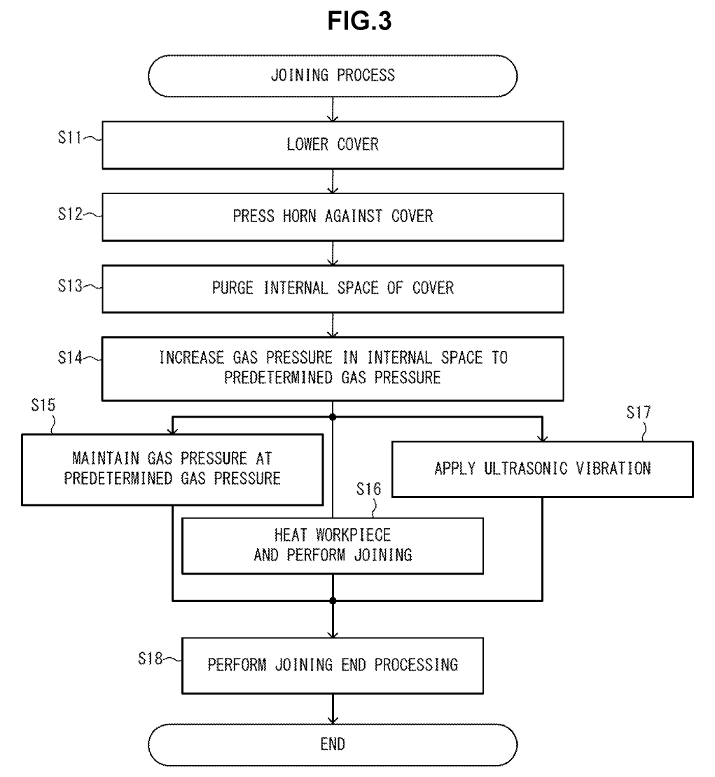

During joining, the controller 90 (more specifically, the processor 92; the same applies hereinafter) performs the joining process shown in FIG. 3. Note that the workpiece W is arranged on the heater 21 at the start of the processing shown in FIG. 3.

During the joining process, first, the controller 90 controls the drive device 40 to lower the cover 30 from an initial upper position (step S11). Then, the cover 30 comes into contact with the upper surface of the component W1 (especially a surface around the component W2 and the joining material M) in a state in which the cover 30 covers the component W2 and the joining material M.

After that, the controller 90 controls the drive device 83 of the device 80 to move the transducer 81 and the horn 82 downward and press the lower end of the horn 82 against the upper surface of the cover 30 (step S12). The horn 82 presses the cover 30 against the component W1 of the workpiece W.

Then, the controller 90 operates the gas supply device 50 and the gas exhaust device 60 to purge the internal space S of the cover 30 for a predetermined period (step S13). More specifically, the controller 90 operates the fan 62 in a state in which the flow control valve 63 is open, thereby exhausting air in the internal space S. Further, the controller 90 opens the flow control valve 53 to supply inert gas from the gas cylinder 51 to the internal space S. As a result, the atmospheric air in the internal space S is exhausted, and the internal space S is filled with the inert gas. Filling with the inert gas suppresses oxidation of the joining material M during joining (to be described later).

Thereafter, the controller 90 controls the gas supply device 50 and the gas exhaust device 60 based on the gas pressure in the internal space S detected by the pressure sensor 70, thereby adjusting amounts of gas supplied to and exhausted from the internal space S and increasing the gas pressure in the internal space S to a predetermined gas pressure (details of which will be described later) (step S14).

The controller 90 controls the gas supply device 50 and the gas exhaust device 60 based on the gas pressure detected by the pressure sensor 70 so as to maintain the gas pressure in the internal space S at the predetermined gas pressure (details of which will be described later) (step S15). The predetermined gas pressure is preferably greater than atmospheric pressure. This allows the inert gas to press the component W2 with a pressure greater than atmospheric pressure, thereby suppressing movement of the component W2.

In parallel with step S15, the controller 90 controls the power supply circuit 25 to heat the workpiece W by the heater 21 and perform joining (step S16). Heating is performed in accordance with a preset temperature profile for achieving a heating temperature corresponding to the material of the joining material M. In parallel with step S15, the controller 90 operates the device 80 during a predetermined period, particularly a period in which the joining material M melts or sinters, during heating to apply ultrasonic vibration to the cover 30 (step S17). The ultrasonic vibration is transmitted to the joining material M via the cover 30 and the component W1. The ultrasonic vibration promotes release of voids from the joining material M during melting or sintering, thereby reducing the residual amount of voids in the joining material M after joining. Note that if the gas pressure in the internal space S is excessively high, release of voids may be hindered. In such a case, the predetermined gas pressure is preferably set to a gas pressure at which release of voids can be ensured.

After the end of steps S15 to S17, the controller 90 performs joining end processing (step S18). The end processing includes any suitable processing such as controlling the gas exhaust device 60 to exhaust gas from the internal space S and controlling the drive device 40 to raise the cover 30.

In step S15, the controller 90 may stop supplying gas to, and exhausting gas from, the internal space S. In this case, both flow control valves 53 and 63 are closed. When the gas pressure in the internal space S detected by the pressure sensor 70 exceeds a predetermined threshold, the controller 90 may control the gas supply device 50 and the gas exhaust device 60 to exhaust gas from the internal space S. At this time, the gas pressure in the internal space S may be maintained or reduced. When the joining material M contains a binder, the binder evaporates during heating of the workpiece W, thereby increasing the gas pressure in the internal space S. With the above-described processing, the evaporated binder can be exhausted.

As described above, the joining system 10 according to this embodiment includes the heater 21 that supports the workpiece W from below and heats the workpiece W, particularly the joining material M, to join the component W1 and the component W2 with the joining material M; the cup-shaped cover 30 that covers, from above, the joining material M and the component W2 of the workpiece W in a non-contact manner during heating of the workpiece W by the heater 21 (in other words, during joining); and the device 80 that applies ultrasonic vibration to the cover 30 during heating of the workpiece W by the heater 21 (in other words, during joining), thereby applying ultrasonic vibration to the workpiece W, particularly the joining material M, via the cover 30. With this configuration, voids are reduced by application of ultrasonic vibration. Further, conventionally, during application of ultrasonic vibration, the workpiece W has been sandwiched from above and below by a horn and a heater tool. In such joining, however, the workpiece W is likely to be deformed or cracked due to pressurization from above and below. According to the above-described configuration, ultrasonic vibration is transmitted to the workpiece W via the cover 30 without sandwiching the workpiece W from above and below. Therefore, deformation and cracking are less likely to occur. As described above, in joining using the joining material M, the above-described configuration can make at least one of problems such as voids in the joining material M, deformation of the workpiece W, and cracks less likely to occur, thereby obtaining good joining quality. Here, making a problem less likely to occur includes reducing an amount of occurrence of the problem, such as reducing an amount of voids. The same applies to other problems.

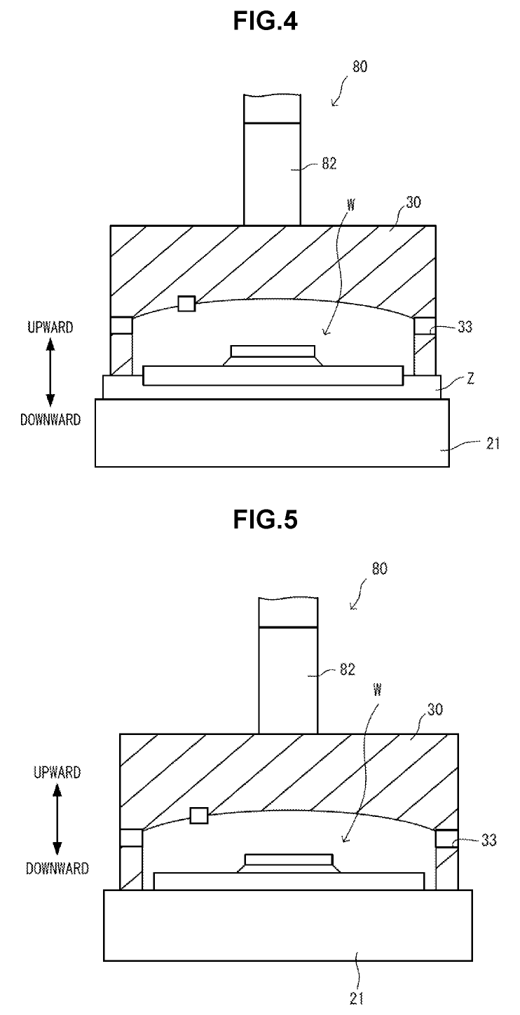

Further, in this embodiment, the device 80 applies ultrasonic vibration to the cover 30 while the cover 30 is pressed against the component W1, thereby applying ultrasonic vibration to the workpiece W. This allows ultrasonic vibration to be transmitted directly from the cover 30 to the workpiece W, thereby enhancing an effect of reducing voids by application of ultrasonic vibration. As shown in FIG. 4, the device 80 may apply ultrasonic vibration to the cover 30 while the cover 30 is pressed against a jig Z that holds the workpiece W, thereby applying ultrasonic vibration to the workpiece W. The jig Z is supported by the heater 21. The workpiece W is fixed to the jig Z. Ultrasonic vibration is applied to the workpiece W via the jig Z. As shown in FIG. 5, the device 80 may apply ultrasonic vibration to the cover 30 while the cover 30 is pressed against the heater 21, thereby applying ultrasonic vibration to the workpiece W. In this case, the workpiece W may be held by a jig. Ultrasonic vibration is applied to the workpiece W via the heater 21. In the examples shown in FIGS. 4 and 5, the cover 30 covers the entire workpiece W in a non-contact manner.

In this embodiment, the joining system 10 further includes a gas supply device 50 that supplies inert gas during joining to the internal space S of the cover 30 that accommodates at least the joining material M and the component W2. This allows the internal space S to be set in an inert-gas atmosphere, making oxidation of the joining material M during joining less likely to occur. Accordingly, good joining quality can be obtained in joining using the joining material M.

In this embodiment, the controller 90 controls the gas supply device 50 so that the gas in the internal space S is at a pressure greater than atmospheric pressure. This allows the component W2 to be pressed by the inert gas. Such pressing can suppress movement of the component W2 during application of ultrasonic vibration. Accordingly, misalignment of the component W2 is less likely to occur, and good joining quality can be obtained in joining using the joining material M. From the viewpoint of suppressing misalignment, the gas supplied to the internal space S need not be inert gas.

Further, the cover 30 includes the top portion 31 that faces the component W2 when the cover 30 covers at least the joining material M and the component W2 in a non-contact manner, and the cylindrical portion 32 that extends downward from the top portion 31 and surrounds at least the joining material M and the component W2 when the cover 30 covers at least the joining material M and the component W2 in a non-contact manner. Further, the through hole 33, which is a gas supply port for supplying inert gas from the gas supply device 50 to the internal space S, is provided in the cylindrical portion 32. This allows the inert gas to be supplied laterally to the internal space S. In particular, by arranging the through hole 33 at a position higher than the workpiece W, that is, a position on the top-portion-31 side, as shown in FIGS. 1, 4, and 5, direct impingement of gas from the gas supply device 50 onto the workpiece W can be suppressed. If the gas directly impinges on the workpiece W, for example, misalignment of the component W2 may occur. However, with the through hole 33 positioned as described above, such misalignment is less likely to occur. In addition, because the ceiling of the internal space S has an upwardly protruding dome shape in accordance with a shape of the workpiece W that protrudes upward at the center due to the component W2, a space between the workpiece W and the ceiling can be increased, thereby securing a gas flow path.

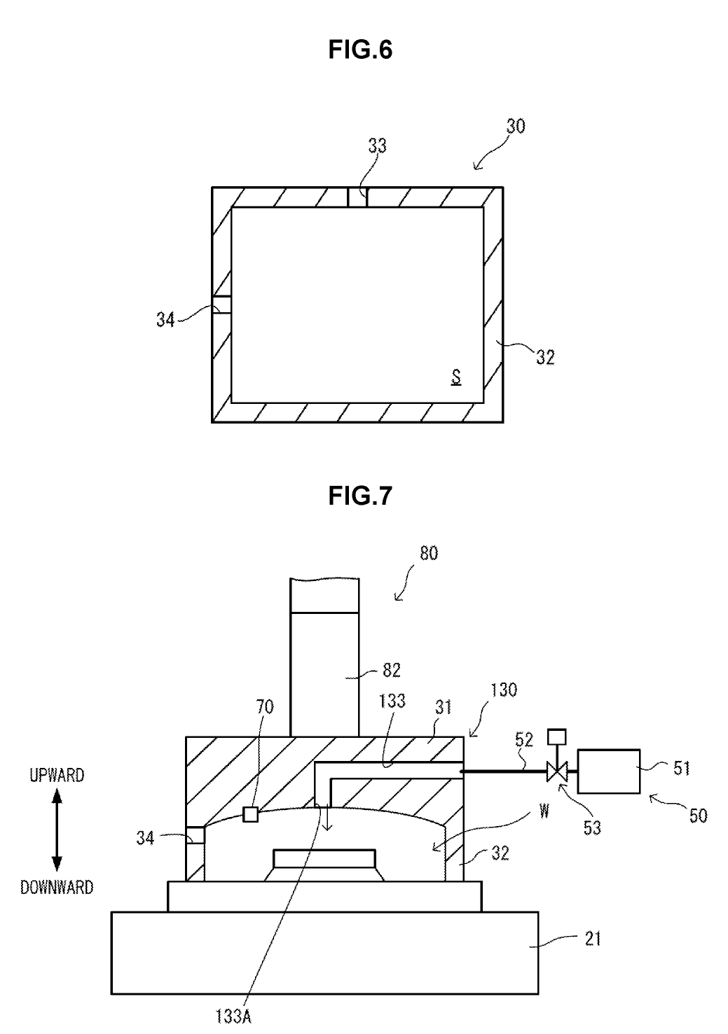

The positions and sizes of the through holes 33 and 34 may be adjusted such that transmission of ultrasonic vibration is not hindered. As shown in FIG. 6, the through holes 33 and 34 may be arranged on two connected surfaces of the cylindrical portion 32. As shown in FIG. 7, the cover 30 may be replaced with a cover 130. The cover 130 has a configuration similar to that of the cover 30, but includes a gas supply path 133 instead of the through hole 33. The gas supply path 133 is formed in the top portion 31 and guides gas from the gas supply device 50 to the internal space S. An end of the gas supply path 133 that communicates with the internal space S, that is, a gas supply port 133A that opens in the lower surface of the top portion 31 and supplies gas to the internal space S, is arranged above the component W2 at a position facing the component W2. With this configuration, gas from the gas supply device 50 can be directed onto the component W2 from above so that the component W2 can be pressed toward the component W1 with a weak force. As a result, misalignment of the component W2 is suppressed, and good joining quality can be obtained in joining using the joining material M. The position of the through hole 34 is arbitrary.

Various modifications can be made to the above-described embodiment. For example, the various configurations described in the above embodiment are optional and may be changed as appropriate. For example, the processor 92 may be constituted by one or more IC chips. Examples of the IC chips include an ASIC (Application Specific Integrated Circuit) and an FPGA (Field-Programmable Gate Array). The programs may be stored in a computer-readable non-transitory storage medium such as the nonvolatile storage 91.

During joining, ultrasonic vibration need not be applied to the cover 30. Even in such a case, the controller 90 may control the gas supply device 50 so that the gas in the internal space S is at a pressure greater than atmospheric pressure. This allows the component W2 to be pressed by the gas. As a result, misalignment of the component W2 is less likely to occur, and good joining quality can be obtained in joining using the joining material M. Another gas, such as air, may be used instead of the inert gas, as described above. A member that presses the cover 30 downward may be a member other than the horn 82, that is, a member that does not apply ultrasonic vibration. The horn 82 may be pressed against the lower surface of the component W1 of the workpiece W through a hole formed in the heater 21 to apply ultrasonic vibration to the workpiece W. The heater 21 may support the workpiece W and heat at least the joining material M of the workpiece W by induction heating. In this case, the heater 21 may include a stage that supports the workpiece W, and a coil provided separately from the stage and arranged such that the joining material M of the workpiece W is positioned inside the coil during joining.

### Supplementary Notes

Set forth below are configurations exemplified by the above-described embodiment and modifications. The configurations set forth in the supplementary notes can be combined with each other.

### Supplementary Note 1

A joining system comprising:
a heater configured to support, from below, a workpiece including a first component, a second component disposed above the first component, and a joining material disposed between the first component and the second component, and to heat at least the joining material to effect joining of the first component and the second component with the joining material;
a cup-shaped cover configured to cover, from above, at least the joining material and the second component of the workpiece in a non-contact manner during the joining; and
an ultrasonic vibration applying device configured to apply ultrasonic vibration to the cover during the joining, thereby applying ultrasonic vibration to the workpiece via the cover.

### Supplementary Note 2

The joining system of Supplementary Note 1, wherein the ultrasonic vibration applying device is configured to apply the ultrasonic vibration to the cover while the cover is pressed against the first component, thereby applying the ultrasonic vibration to the workpiece.

### Supplementary Note 3

The joining system of Supplementary Note 1, wherein the ultrasonic vibration applying device is configured to apply the ultrasonic vibration to the cover while the cover is pressed against a jig holding the workpiece, thereby applying the ultrasonic vibration to the workpiece.

### Supplementary Note 4

The joining system of Supplementary Note 1, wherein the ultrasonic vibration applying device is configured to apply the ultrasonic vibration to the cover while the cover is pressed against the heater, thereby applying the ultrasonic vibration to the workpiece.

### Supplementary Note 5

The joining system of any one of Supplementary Notes 1 to 4, further comprising a gas supply device configured to supply inert gas during the joining to an internal space of the cover that accommodates at least the joining material and the second component.

### Supplementary Note 6

The joining system of any one of Supplementary Notes 1 to 5 further comprising:
a gas supply device configured to supply gas during the joining to an internal space of the cover that accommodates at least the joining material and the second component; and
a controller configured to control the gas supply device such that the gas in the internal space is at a pressure greater than atmospheric pressure.

### Supplementary Note 7

The joining system of Supplementary Note 6, wherein
the cover comprises:
   a top portion configured to face the second component when the cover covers at least the joining material and the second component in a non-contact manner; and
   a cylindrical portion that extends downward from the top portion and is configured to surround at least the joining material and the second component when the cover covers at least the joining material and the second component in a non-contact manner, the cylindrical portion including a supply port configured to supply the gas from the gas supply device to the internal space.

### Supplementary Note 8

The joining system of Supplementary Note 6 or 7, wherein
the cover comprises:
   a top portion configured to face the second component when the cover covers at least the joining material and the second component in a non-contact manner, the top portion including a supply port configured to supply the gas from the gas supply device to the internal space; and
   a cylindrical portion that extends downward from the top portion and is configured to surround at least the joining material and the second component when the cover covers at least the joining material and the second component in a non-contact manner;
   wherein the supply port is located at a position facing the second component when the cover covers at least the joining material and the second component in a non-contact manner.

### Supplementary Note 9

The joining system of any one of Supplementary Notes 1 to 8, wherein
the joining material includes one selected from the group consisting of a brazing material, a solder, a sintering material, a thermoplastic resin, and a thermosetting resin.

### Supplementary Note 10

A joining system comprising:
a heater configured to support, from below, a workpiece including a first component, a second component disposed above the first component, and a joining material disposed between the first component and the second component, and to heat at least the joining material to effect joining of the first component and the second component with the joining material;
a cup-shaped cover configured to cover, from above, at least the joining material and the second component of the workpiece in a non-contact manner during the joining;
a gas supply device configured to supply gas during the joining to an internal space of the cover that accommodates at least the joining material and the second component; and
a controller configured to control the gas supply device such that the gas in the internal space is at a pressure greater than atmospheric pressure.

### Scope of Present Disclosure

The present disclosure has been described above with reference to the embodiments and modifications. However, the present disclosure is not limited to the above-described embodiments and modifications. For example, the present disclosure includes various modifications to the above-described embodiments and modifications that can be understood by those skilled in the art within the technical concept of the present disclosure. The configurations described in the above-described embodiments and modifications may be combined as appropriate insofar as no inconsistency arises. Omission of any of the configurations is also optional.

### INCORPORATION BY REFERENCE

This application claims the benefit of Japanese Patent Application No. 2025-055582, filed on Mar. 28, 2025, the entire disclosure of which is incorporated by reference herein.

### EXPLANATION OF THE REFERENCE NUMERALS AND SIGNS

10...joining system, 21...heater, 21A...heat source, 25...power supply circuit, 30...cover, 31...top portion, 32...cylindrical portion, 33...through hole, 34...through hole, 40...drive device, 50...gas supply device, 51...gas cylinder, 52...gas pipe, 53...flow control valve, 60...gas exhaust device, 61...exhaust pipe, 62...fan, 63...flow control valve, 70...pressure sensor, 80...ultrasonic vibration applying device, 81...ultrasonic transducer, 82...ultrasonic horn, 83...drive device, 84...power supply circuit, 90...controller, 91...storage, 92...processor, 93...main memory, 130...cover, 133...gas supply path, 133A...gas supply port, M...joining material, S...internal space, W...workpiece, W1...component, W2...component, Z...jig.

1. A joining system comprising:
a heater configured to support, from below, a workpiece including a first component, a second component disposed above the first component, and a joining material disposed between the first component and the second component, and to heat at least the joining material to effect joining of the first component and the second component with the joining material;
a cup-shaped cover configured to cover, from above, at least the joining material and the second component of the workpiece in a non-contact manner during the joining; and
an ultrasonic vibration applying device configured to apply ultrasonic vibration to the cover during the joining, thereby applying ultrasonic vibration to the workpiece via the cover.

2. The joining system of claim 1, wherein
the ultrasonic vibration applying device is configured to apply the ultrasonic vibration to the cover while the cover is pressed against the first component, thereby applying the ultrasonic vibration to the workpiece.

3. The joining system of claim 1, wherein
the ultrasonic vibration applying device is configured to apply the ultrasonic vibration to the cover while the cover is pressed against a jig holding the workpiece, thereby applying the ultrasonic vibration to the workpiece.

4. The joining system of claim 1, wherein
the ultrasonic vibration applying device is configured to apply the ultrasonic vibration to the cover while the cover is pressed against the heater, thereby applying the ultrasonic vibration to the workpiece.

5. The joining system of claim 1, further comprising
a gas supply device configured to supply inert gas during the joining to an internal space of the cover that accommodates at least the joining material and the second component.

6. The joining system of claim 1, further comprising:
a gas supply device configured to supply gas during the joining to an internal space of the cover that accommodates at least the joining material and the second component; and
a controller configured to control the gas supply device such that the gas in the internal space is at a pressure greater than atmospheric pressure.

7. The joining system of claim 6, wherein
the cover comprises:
a top portion configured to face the second component when the cover covers at least the joining material and the second component in a non-contact manner; and
a cylindrical portion that extends downward from the top portion and is configured to surround at least the joining material and the second component when the cover covers at least the joining material and the second component in a non-contact manner, the cylindrical portion including a supply port configured to supply the gas from the gas supply device to the internal space.

8. The joining system of claim 6, wherein
the cover comprises:
a top portion configured to face the second component when the cover covers at least the joining material and the second component in a non-contact manner, the top portion including a supply port configured to supply the gas from the gas supply device to the internal space; and
a cylindrical portion that extends downward from the top portion and is configured to surround at least the joining material and the second component when the cover covers at least the joining material and the second component in a non-contact manner;
wherein the supply port is located at a position facing the second component when the cover covers at least the joining material and the second component in a non-contact manner.

9. The joining system of claim 1, wherein
the joining material includes one selected from the group consisting of a brazing material, a solder, a sintering material, a thermoplastic resin, and a thermosetting resin.

10. A joining system comprising:
a heater configured to support, from below, a workpiece including a first component, a second component disposed above the first component, and a joining material disposed between the first component and the second component, and to heat at least the joining material to effect joining of the first component and the second component with the joining material;
a cup-shaped cover configured to cover, from above, at least the joining material and the second component of the workpiece in a non-contact manner during the joining;
a gas supply device configured to supply gas during the joining to an internal space of the cover that accommodates at least the joining material and the second component; and
a controller configured to control the gas supply device such that the gas in the internal space is at a pressure greater than atmospheric pressure.
